(19) United States
(12) Patent Application Publication
(10) Pub. No.: US 2014/0218505 A1
(43) Pub. Date: Aug. 7, 2014

(54) DIGITAL MICROFORM READER AND METHOD

(71) Applicant: Evis R. Beaton, Monument, CO (US)

(72) Inventor: Evis R. Beaton, Monument, CO (US)

(21) Appl. No.: 13/007,066

(22) Filed: Jan. 14, 2011

Related U.S. Application Data
(60) Provisional application No. 61/412,881, filed on Nov. 12, 2010.

(51) Int. Cl. H04N 1/00

(52) U.S. Cl. CPC H04N 1/00267; H04N 2201/041
USPC 348/112; 29/401.1

(57) ABSTRACT

The invention is directed to a digital microform reader that has a form carrier. A light projection system projects light onto the form carrier. A digital imaging system images a portion of the form carrier. A computer communication data interface system receives an electronic image from the digital imaging system, wherein the digital microform reader does not contain a viewer. A light diffusion sheet may be used with a condenser lens of the light projection system. The digital imaging system includes a CMOS (Complementary Metal Oxide Semiconductor) detector. CMOS detectors are able to capture an image much faster than CCD (Charge Coupled Device) detectors. Because the system does not have a separate viewer it is much less expensive than prior art systems. The system also uses less energy than prior art machines because of its use of light diffusion sheets with the condenser lens and as a background for the microform.

### RELATED APPLICATIONS

The present invention claims priority on Provisional patent application, Ser. No. 61/412881, filed on Nov. 12, 2010, entitled “Digital Microform reader” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Microfilm and microfiche (microform) can only be viewed with a special viewer. These viewers are generally standalone machines that magnify the image and have a screen for viewing the images. They may also include a printer function. These printers are expensive, use a lot of energy and require the user to purchase special printing supplies. New microform readers may include the ability to digitally store images, but still have a screen and are standalone machines. As a result, these machines are very expensive.

Thus there exists a need for an inexpensive microform reader.

### BRIEF SUMMARY OF INVENTION

A digital microform reader that overcomes these and other problems includes a form carrier. A light projection system projects light onto the form carrier. A digital imaging system images a portion of the form carrier. A computer communication data interface system receives an electronic image from the digital imaging system, wherein the digital microform reader does not contain a viewer. In one embodiment, the digital microform reader uses a low power projection lamp that is rated less than 25 watts. This saves on operating expenses. A light diffusion sheet may be used with a condenser lens of the light projection system. The digital imaging system includes a CMOS (Complementary Metal Oxide Semiconductor) detector. CMOS detectors are able to capture an image much faster than CCD (Charge Coupled Device) detectors. Because the system does not have a separate viewer it is much less expensive than prior art systems. The system also uses less energy than prior art machines because of its use of light diffusion sheets with the condenser lens and as a background for the microform.

In operation, the user first installs a camera driver on their computer. The user then installs an image capture software. The digital microform reader is connected to the computer using a standard computer communication cable, such as a USB cord. The user then places the microform in the form carrier and turns on the light. The user then adjusts the focus using a focus knob. The zoom is controlled by moving the housing holding the CMOS camera up and down. Once an image is viewed on the computer with the camera driver software it can be captured and manipulated using the image capture software. Because the system uses a computer it does not need a viewer, it also can use off the shelf image capture software. This significantly reduces the cost of the microform reader. It also significantly increases the value over a standalone viewer. Since the images are already stored on a computer they can be cropped, rotated, combined with other images and easily sent to other computers.

### BRIEF DESCRIPTION OF THE SEVERAL VIEWS OF THE DRAWINGS

FIG. 1 is a system diagram of a digital microform reader connected to a computer in accordance with one embodiment of the invention;

FIG. 2 is a block diagram of a digital microform reader in accordance with one embodiment of the invention;

FIG. 3 is a flow chart of the steps used in operating a digital microform reader in accordance with one embodiment of the invention; and

FIG. 4 is a perspective view of a microform retrofit system in accordance with one embodiment of the invention.

### DETAILED DESCRIPTION OF THE INVENTION

The invention is directed to a digital microform reader that has a form carrier. A light projection system projects light onto the form carrier. A digital imaging system images a portion of the form carrier. A computer communication data interface system receives an electronic image from the digital imaging system, wherein the digital microform reader does not contain a viewer. In one embodiment, the digital microform reader uses a low power projection lamp that is rated less than 25 watts. This saves on operating expenses. A light diffusion sheet may be used with a condenser lens of the light projection system. The digital imaging system includes a CMOS ((Complementary Metal Oxide Semiconductor) detector. CMOS detectors are able to capture an image much faster than CCD (Charge Coupled Device) detectors. Because the system does not have a separate viewer it is much less expensive than prior art systems. The system also uses less energy than prior art machines because of its use of light diffusion sheets with the condenser lens and as a background for the microform.

In operation, the user first installs a camera driver on their computer. The user then installs an image capture software. The digital microform reader is connected to the computer using a standard computer communication cable, such as a USB cord. The user then places the microform in the form carrier and turns on the light. The user then adjusts the focus using a focus knob. The zoom is controlled by moving the housing holding the CMOS camera up and down. Once an image is viewed on the computer with the camera driver software it can be captured and manipulated using the image capture software. Because the system uses a computer it does not need a viewer, it also can use off the shelf image capture software. This significantly reduces the cost of the microform reader. It also significantly increases the value over a standalone viewer. Since the images are already stored on a computer they can be cropped, rotated, combined with other images and easily sent to other computers.

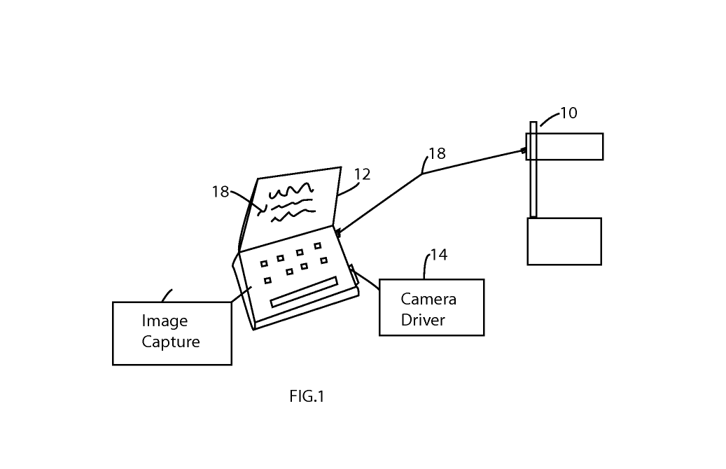

FIG. 1 is a system diagram of a digital microform reader 10 connected to a computer 12 in accordance with one embodiment of the invention. The digital microform reader 10 captures an electronic image and transfers it to a computer 12. The computer 12 has a camera digital driver 14 that allows the digital camera of the digital microform reader 10 to communicate with the computer 12. The computer 12 also contains an image capture software 16. The image capture software 16 allows the user to capture, edit, and store images on the computer 12 as well as print images on a network printer. The computer 12 is connected to the digital microform reader 10 by a standard computer communication cable 18, such as a USB (Universal Serial Bus) cable. A major advantage of the present invention is that it does not have its own viewing system. The digital microform reader uses the monitor 18 of the computer 12. Since most people have a computer and the digital microform reader will work with a wide variety of computers this significantly reduces the cost of the obtaining a microform reader. It also provides additional flexibility to the users. It allows them to easily store microform reader images. The images can be cropped, rotated, image enhanced, and combined with other images with ease because the images are already on the computer. It also makes it easier to transfer images to other people.

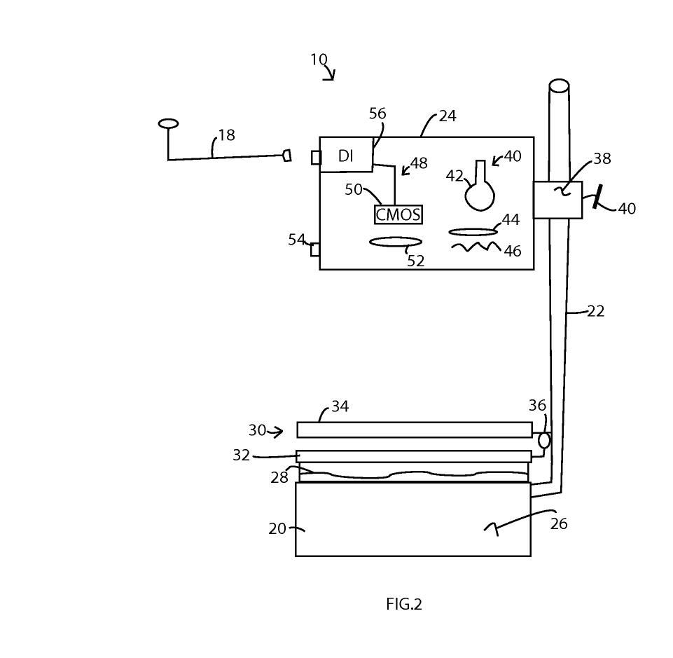

FIG. 2 is a block diagram of a digital microform reader 10 in accordance with one embodiment of the invention. The reader 10 has a form carrier 20 with a guide 22. A housing 24 is attached to the guide 22. The form carrier 20 includes a base 26 with a diffusion sheet 28 on top of the base 26. A glass form capture device 30 has a lower glass plate 32 and an upper glass plate 34 connected by hinge 36. The microform is placed between the upper and lower glass plates. The lower glass plate 32 is attached to the base in one embodiment.

The housing 24 is attached to the guide 22 by a guide mechanism 38 The guide mechanism 38 holds the housing to the guide 22 and includes a guide attachment mechanism 38 to move the housing 24 closer or farther from the form carrier 20. The guide attachment mechanism 38 is operated using a knob 40 in one embodiment. The guide attachment mechanism is well known in the art of microform systems and any of these attachment mechanism are within the scope of the present invention. Inside the housing 24 is a light projection system 40. The light projection system 40 includes a light source 42, a condenser lens 44, and a light diffuser 46. The housing 24 includes a digital imaging system 48. The digital imaging system 48 includes a CMOS (Complementary Metal Oxide Semiconductor) camera 50, which includes a CMOS detector. Imaging optics 52 focus the camera 52 on the form. The imaging optics 52 includes a focusing system that is operated by the focus knob 54. The camera 50 is in communication with a computer communication data interface system 56. The computer communication data interface system 56 connects to a standard computer cable 18 such as a USB cable.

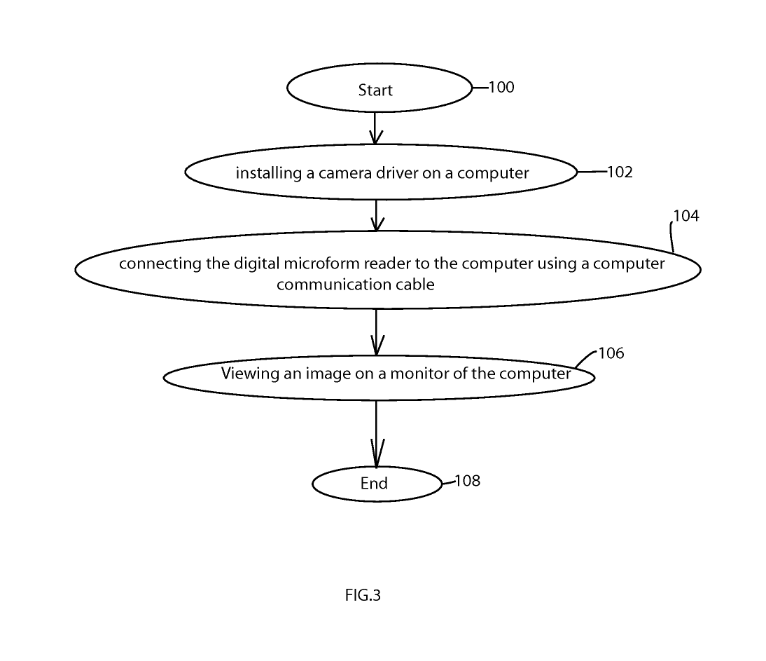

FIG. 3 is a flow chart of the steps used in operating a digital microform reader in accordance with one embodiment of the invention. The process starts, step 100, by installing a camera driver on a computer at step 102. The digital microform reader is connected to the computer using a computer communication cable at step 104. At step 106, the image is viewed on a monitor of the computer, which ends the process at step 108. In one embodiment, an image capture software is also installed. This allows the user to capture, store, edit, and combine images. It also makes it easy to transfer the image to other computers.

Thus there has been described a simple to use, inexpensive digital microform reader. The use of a CMOS digital camera allows the reader to quickly acquire images compared to CCD type cameras. The reader takes advantage that most users have computers and integrates with an existing computer. This increases the feature set while reducing the cost of the microform reader. It also eliminates the need for a built in viewer and a built in printer. This saves the user the additional cost associated with a built in printer, the high energy consumption of these built in printers and saves them from having to buy expensive supplies for these built in printers.

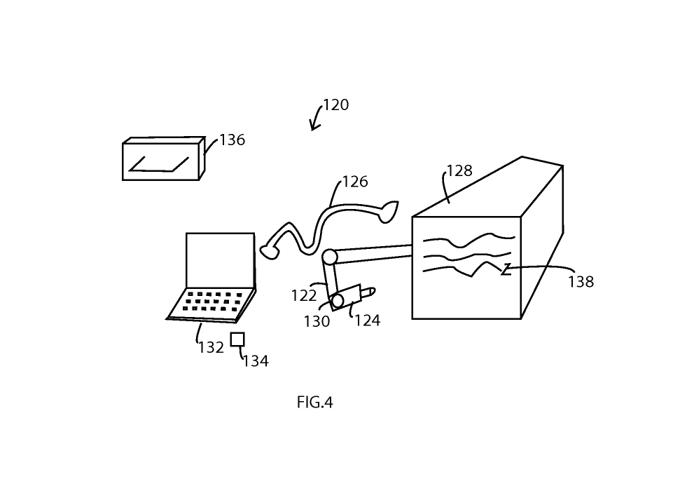

FIG. 4 is a perspective view of a microform retrofit system 120 in accordance with one embodiment of the invention. The retrofit system 120 includes an articulating arm 122, a digital camera 124, a computer communication cable 126 and any associated software. The articulating arm 122 is mounted to a microform reader 128 or mounted to a workstation or wall near the microform reader 128. The articulating arm 122 has a first end with a standard camera mount 130. The digital camera 124 is attached to the camera mount 130. A computer communication cable 126 attaches to the digital camera 124 and to a computer 132. The computer 132 includes a camera driver 134. It may also includes screen capture software 134. The computer 132 may be connected to printer 136.

In operation, the user attaches the articulating arm 122 to the microform reader 128. The user then positions the articulating arm 122 so that camera 124 is pointed at the microform screen 138. The camera driver 134 is installed on the computer 132. The communication cable 126 is attached to the camera 124 and the computer 132. The camera 124 is turned on and focused on the screen 138. The user can then use image capture software 134 to print the image on the printer 136 or to edit the image or send the image to another computer.

In one embodiment, the digital camera is not auto-focusing. It has been found that auto-focusing cameras do not focus well on light sources.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A digital microform reader, comprising:
a form carrier;
a light projection system projects light onto the form carrier;
a digital imaging system imaging a portion of the form carrier; and
a computer communication data interface system receiving an electronic image from the digital imaging system, wherein the digital microform reader does not contain a viewer.

2. The reader of claim 1, wherein the light projection system includes a projection lamp that has an output that is less than 25 watts.

3. The reader of claim 1, wherein the light projection system includes a condenser lens with a light diffusion sheet.

4. The reader of claim 1, wherein the form carrier has a lower glass with a light diffusion sheet attached.

5. The reader of claim 1, wherein the digital imaging system includes a CMOS (Complementary Metal Oxide Semiconductor) detector.

6. The reader of claim 1, further including a computer driver software that communicates with the digital imaging system through the computer communication data interface system.

7. A method of operating a digital microform reader, comprising the steps of:
installing a camera driver on a computer;
connecting the digital microform reader to the computer using a computer communication cable;
viewing an image on a monitor of the computer, wherein the digital microform reader does not contain a viewer.

8. The method of claim 7, wherein the step of viewing the image includes the step of turning on a light in the digital microform reader.

9. The method of claim 7, wherein the step of installing a camera driver on a computer includes the step of installing an image capture software.

10. The method of claim 7, wherein the step of viewing the image includes the steps of turning on a light, placing a form in a form holder of the digital microform reader, and adjusting a focus of the digital microform reader.

11. A digital microform reader, comprising:
a housing;
a guide attachment mechanism in the housing for attaching to a guide;
an imaging optics attached to the housing;
a CMOS digital camera inside the housing; and
a computer communication data interface system receiving an electronic image from the digital imaging system, wherein the digital microform reader does not contain a viewer.

12. The digital microform reader of claim 11, wherein the imaging optics includes a light diffusion sheet.

13. The digital microform reader of claim 12, further including a form carrier that is imaged by the imaging optics.

14. The digital microform reader of claim 13, wherein the form carrier has a lower glass with a light diffusion sheet attached.

15. The digital microform reader of claim 14, further including a computer driver software that communicates with the CMOS digital camera through the computer communication data interface system.

16. A microform reader retrofit system, comprising:
an articulating arm having a mounting system at a first end of the articulating arm;
a digital camera attached the mounting system; and
a computer cable attached to the digital camera.

17. The retrofit system of claim 16, wherein the digital camera is not auto focusing.

18. The retrofit system of claim 16, further including a camera driver installed on a computer and communicating with the digital camera.

19. The retrofit system of claim 18, further including an image capture software communicating with the camera driver.

20. A method of retrofitting a microform reader, comprising the steps of:
installing a camera driver on a computer;
attaching an articulating arm; and
adjusting the articulating arm so a digital camera attached to the articulating arm is focusing on a screen of a microform reader.

21. The method of claim 20, wherein the step of attaching the articulating arm includes the step of mounting the articulating arm to the microform reader.

22. The method of claim 20, wherein the step of attaching an articulating arm includes the step of mounting the digital camera to the articulating arm.

23. The method of claim 20, wherein the step of adjusting the articulating arm includes the step of connecting a computer communication cable from the digital camera to a computer.
